(19) United States
(12) Patent Application Publication
(10) Pub. No.: US 2026/0010489 A1
(43) Pub. Date: Jan. 8, 2026

(54) WRITE-ONLY SWAPPING OF MEMORY PAGES IN A COMPUTING ENVIRONMENT

(71) Applicant: RED HAT, INC., Raleigh, NC (US)

(72) Inventors: Michael Tsirkin, Yokneam Illit (IL); Amnon Ilan, Ra'anana (IL)

(21) Appl. No.: 18/764,480

(22) Filed: Jul. 5, 2024

(51) Int. Cl. G06F 12/123

(52) U.S. Cl. CPC G06F 12/123

(57) ABSTRACT

Techniques described herein relate to performing write-only swapping of memory pages in a computing environment. For example, the computing environment can execute one or more processes accessing memory pages. The computing environment can request, by a process of the one or more processes, a new memory page. The computing environment can determine that a memory consumption limit predefined for the memory device has been exceeded by the one or more processes. The computing environment can, in response to (i) requesting the new memory page and (ii) determining that the memory consumption limit has been exceeded, discard an existing memory page. The computing environment can allocate the new memory page for the process subsequent to discarding the existing memory page.

### TECHNICAL FIELD

The present disclosure relates generally to memory management in a computing environment. More specifically, but not by way of limitation, this disclosure relates to write-only swapping of memory pages in a computing environment.

### BACKGROUND

A memory page is a fixed-length block of contiguous virtual memory, described by a single entry in a page table. A memory page is the smallest unit of memory for memory management in an operating system that uses virtual memory. Some operating systems may perform memory paging (e.g., swapping) to store and retrieve memory pages from secondary storage (e.g., hard disk drive or solid-state drive) for use in main memory (e.g., random-access memory (RAM)). Using memory pages in secondary storage can allow processes to exceed the size of the available physical memory in main memory.

### BRIEF DESCRIPTION OF THE DRAWINGS

FIG. 1 is a block diagram of an example of a computing system for write-only swapping of memory pages, according to some aspects of the present disclosure.

FIG. 2 is a block diagram of another example of a computing system for write-only swapping of memory pages, according to some aspects of the present disclosure.

FIG. 3 is a flowchart of an example of a process for write-only swapping of memory pages in a computing system, according to some aspects of the present disclosure.

### DETAILED DESCRIPTION

Memory may be a constraining resource for some computing environments, particularly for edge devices or internet-of-things (IOT). Various overcommitment techniques may conventionally be used to compensate, such as memory swapping. For instance, virtual machines (or other processes) may be assigned more virtual memory than is present in physical memory of a host machine, as virtual machines may not use all available memory at any one point, thus creating a buffer. Memory swapping can be used to handle spikes in memory usage, such as by storing and retrieving memory pages in secondary storage. Alternatively, kernel same-page merging (KSM) can allow a hypervisor to share memory pages with identical contents between multiple processes or virtual machines. But conventional overcommitment techniques may have I/O costs (e.g., for memory swapping) or central processing unit (CPU) costs (e.g., for KSM), or may result in inefficient memory usage or undesirable latency. For instance, it may be common for a memory page to be allocated in secondary storage, used shortly by a process, then never used again.

Some examples of the present disclosure can overcome one or more of the issues mentioned above by a computing system performing write-only swapping of memory pages. Upon reaching a memory consumption limit, when a new memory page is to be allocated for a process, an existing memory page can be selected. Instead of writing the memory page to disk (e.g., by performing memory swapping), compressing the memory page (e.g., using zram), or deduplicating the existing memory page (e.g., by performing KSM), the contents of the existing memory page can be discarded. The existing (e.g., discarded) memory page can be marked as missing. The new memory page can then be allocated using the newly available memory. As the discarded memory page may no longer be needed, processes can keep running. But if a process attempts to access the discarded memory page, a fault (e.g., a page fault) can be triggered that may kill the process. The operating system may then restart the process as necessary. Writing memory pages without swapping existing memory pages (e.g., performing write-only swap) can significantly reduce CPU costs and improve memory usage and efficiency compared to conventional techniques. Further, by discarding memory, overhead and security concerns can be bypassed entirely.

One particular example can involve a computing system executing a group of processes, such as applications, containers on a single host, virtual machines of a single tenant, etc. The processes may, in some examples, be allocated more virtual memory than is present as physical memory on the computing system (e.g., via overcommitment). For example, a first process may write a first memory page of virtual memory. The first process may directly or indirectly request a first memory page to be allocated. For example, the first process may indirectly request this by accessing the first memory page. Access to the first memory page may be controlled by an operating system of the computing system. In another example, the first process may directly request memory allocation from the operating system. In some examples, the first memory page may not be accessed subsequently by the first process. Then, a second process may need to write a second memory page of virtual memory. But, the memory consumption of the computing system may have exceeded a predefined limit, thus preventing writing of the second memory page. To enable writing of the second memory page, the computing system can select a memory page to discard.

In some examples, the computing system may select the memory page to discard using a least recently used (LRU) policy. The LRU memory page may be the memory page with the oldest “age” (e.g., the greatest length of time that has passed since the memory page was last accessed). Memory pages that have not been accessed for relatively long amounts of time may indicate their lower priority or that they may no longer be needed by the processes. For example, the first memory page may be the LRU memory page for the computing system and may thus be selected to discard.

In other examples, the computing system may select a memory page to discard based on an out-of-memory (OOM) score for an associated process. For example, the OOM score may indicate how likely the process is to be terminated in case of low available memory. The score may be proportional to the amount of memory used by the process. The first process may be the process with the highest OOM score, and thus the computing system may select the first memory page written by the first process to discard. In another example, the computing system may select the memory page to discard based on a combination of LRU policy and OOM scores. For example, the computing system may select the memory page (e.g., the second memory page) who's use time (e.g., time since last access) multiplied by the OOM score of the corresponding process (e.g., the second process) is highest.

Once the computing system discards the first memory page, the second process can write the second memory page of virtual memory. In other words, the computing system can perform a write-only swap in which the second memory page is written without swapping the second memory page (e.g., to a swap device). The first process may or may not need to access the discarded first memory page again. If not, the first process can execute as normal. If the first process does attempt to access the discarded first memory page, the computing system can kill and, if necessary, restart the first process.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

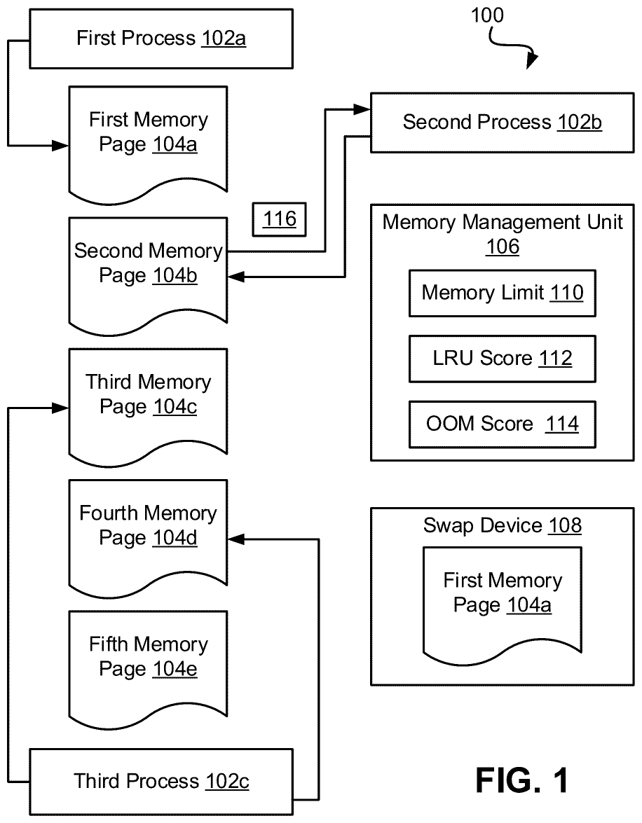

FIG. 1 is a block diagram of an example of a computing system 100 for write-only swapping of memory pages 104a-e, according to some aspects of the present disclosure. In some examples, the computing system 100 may be a distributed computing environment that includes multiple devices in communication via a network, such as a local area network or the Internet. Alternatively, the computing system 100 may be a single device, such as a laptop, desktop, or any other suitable computing device. The computing system 100 can execute processes 102a-c, such as virtual machines, applications, one or more containers (e.g., on a single host), etc. A process 102 can be an execution of instructions loaded into memory of the computing system 100, such as memory pages 104a-e.

Each of the memory pages 104a-e may be a fixed-length contiguous block of virtual memory, which can each be described as a single entry in a page table managed by a memory management unit (MMU) 106. The page table can map the virtual address of a memory page 104 to its corresponding physical address of physical memory of the computing system 100. The virtual addresses may be used by the processes 102a-c, while the physical addresses may be used by hardware of the computing system 100, such as random-access memory (RAM).

The computing system 100 can include a memory management unit (MMU) 106 that can provide virtual memory support for the computing system 100. The MMU 106 can help facilitate memory operations requested by the processes 102a-c. For example, the MMU 106 can translate virtual addresses of memory pages 104a-e (e.g., in virtual memory) to physical addresses in physical memory.

The processes 102a-c may access (e.g., read from) existing memory pages 104 or may write new memory pages 104. For example, the second memory page 104b request allocation (e.g., writing) of the second memory page 104b to virtual memory. The second memory page 104b may persist. Each time the second memory page 104b is accessed (e.g., read or modified) by any of the processes 102a-c, the MMU 106 can record the access time.

In some examples, the computing system 100 can assign more virtual memory to the processes 102a-c than is present in physical memory for the computing system 100. For example, the processes 102a-c may be virtual machines that do not necessarily use as much memory at any one point as they are assigned. Thus, there may be unused virtual memory that can be assigned to additional processes. But as the assigned virtual memory may exceed the physical memory, in some examples, executing the processes 102a-c may reach a memory limit 110 for the computing system 100. Thus, it may be beneficial to perform write-only swapping in which a new memory page is written to virtual memory while discarding an existing memory page.

For example, the first process 102a may request a new memory page (e.g., first memory page 104a). But, the memory limit 110 of the computing system 100 may be met or exceeded, preventing the first memory page 104a from being allocated. Thus, the computing system 100 may select one of the memory pages 104a-e to discard to free memory space for the first memory page 104a. For example, the computing system 100 may select a memory page 104 based on a least recently used (LRU) score 112. The LRU score 112 can be based on the last access time recorded by the MMU 106. Higher LRU scores can indicate longer times since a process 102 has accessed a particular memory page 104. It may be beneficial to discard pages that have not been accessed as recently as other pages. Thus, the computing system 100 can select the second memory page 104b, which may have the highest LRU score 112 among the memory pages 104a-d, to discard.

Additionally or alternatively, the computing system 100 may select the memory page to discard based on an out-of-memory (OOM) score 114. For example, the computing system 100 may assign an OOM score 114 to each of the processes 102a-c. The OOM score 114 can indicate a likelihood that the corresponding process 102 will be terminated in case of low available memory. The OOM score 114 can be proportional to the amount of memory used by the process 102. For example, the OOM score 114 can be calculated as the percent of memory used by the process 102.

The computing system 100 may select a memory page to discard based on the OOM score 114 by identifying the process, such as the second process 102b, that has the highest OOM score 114. The computing system 100 can then select a memory page 104 that was allocated by the second process 102b, such as second memory page 104b, to discard. In some examples, the computing system 100 may select a memory page to discard based on both OOM scores 114 and LRU scores 112. For example, the computing system 100 can select the memory page to discard by multiplying the LRU score 112 for each memory page 104 by the OOM score 114 for the process 102 that allocated the corresponding memory page 104, thus generating an adjusted LRU score. The memory page with the highest adjusted LRU score (e.g., the second memory page 104b) may be selected to discard.

Once selected, the computing system 100 can discard the second memory page 104b. For example, the data from the second memory page 104b can be discarded, without writing the data to another storage device (e.g., swap device 108). This can allow the newly freed memory to be allocated to the first memory page 104a requested by the first process 102a. Thus, write-only swaps can be performed by the computing system 100. Or, in other examples, the data from the second memory page 104b can be moved to the swap device 108 to be discarded. The swap device 108 may discard the data from the second memory page 104b without creating a copy of the second memory page 104b. When a process requests access (e.g., a read request) to the second memory page 104b, the swap device 108 may return a read error to the process.

In some examples, write-only swaps can be combined with other memory management techniques, such as memory swapping to the swap device 108 of the computing system 100. For example, the third process 102c may request a third memory page 104c. Upon determining that the memory limit 110 (e.g., a first memory limit) for virtual memory has been exceeded, the computing system 100 can move a selected memory page to the swap device 108. For example, the computing system 100 may select the first memory page 104a to move to the swap device 108, such as by using any of the techniques described above. After moving data from the first memory page 104a to the swap device 108, thus freeing memory, the computing system 100 can allocate the third memory page 104c for the third process 102c in virtual memory.

But, in some examples, the available memory in the swap device 108 may also be fully allocated, leaving no available memory in the computing system 100 to be allocated. For example, after moving the first memory page 104a to the swap device 108, the third process 102c may request a fourth memory page 104d. As memory limits for both the virtual memory of the computing system 100 and for the swap device 108 may be exceeded, the computing system 100 may select a memory page to discard using write-only techniques (e.g., as described above). For example, the computing system 100 may select a fifth memory page 104e to discard. The computing system 100 can discard data from the fifth memory page 104e without writing the data to another storage device, thus freeing memory. The freed memory can be used to allocate the fourth memory page 104d for the third process 102c.

In some examples, the processes 102a-c may attempt to access (e.g., read from) the discarded memory pages (e.g., second memory page 104b and fifth memory page 104e) but may be unable to do so. For example, the second process 102b may request access to the second memory page 104b. In response, the computing system 100 may kill the second process 102b. In some examples, if execution of the second process 102b is required, the computing system 100 may then restart the second process 102b. As it may be common for data from discarded memory pages to never or rarely be accessed again, killing and restarting processes 102 that attempt to do so may still consume fewer computing resources than performing memory swapping, compression, or other conventional memory management techniques. This may particularly be the case for modern, distributed containerized applications that are built to withstand error and can fail and restart without significant impact to latency or resource consumption. Techniques applied herein may also be beneficial for applications that can run on edge devices that can similarly tolerate failures and restarts, or virtual machines in cloud environments, for example.

In some examples, a signal may be sent to a process 102 when an associated memory page 104 is discarded. The signal may indicate that the associated memory page 104 has been discarded. The signal may in some examples cause the process 102 to be killed. Alternatively, some processes 102a-c may be robust enough to handle access failures without needing to be killed, such as by instead reporting a signal such as an error to the process. For example, if the second process 102b requests access to discarded data from the second memory page 104b, the computing system 100 may send a segmentation fault 116 to the second process 102b. In some examples, the second process 102b may be configured to recover from the segmentation fault 116 and may continue execution. In other examples, the segmentation fault 116 may trigger the second process 102b to be killed.

For example, the second process 102b may be a virtual machine. Virtual machines are one popular mechanism for deploying relatively isolated virtual computing environments on a physical computer system (e.g., computing system 100). A virtual machine typically includes virtualized hardware and guest software. The virtualized hardware can emulate physical computer hardware. Examples of the virtualized hardware can include virtual central processing units (vCPUs), virtual random-access memory (vRAM), virtual network interfaces, and virtual storage. For example, the virtual machine may include virtual memory pages (e.g., second memory page 104b). The guest software can be any software programs that execute on top of the virtual machine. Examples of the guest software can include a guest operating system, a guest supervisory program, and one or more guest applications that can execute in userspace. Guest software is generally given limited access to the physical resources of the underlying computing system 100.

A hypervisor can be a software layer that sits below the virtual machine and above the physical hardware of the computing system 100. The hypervisor can provide interfaces between the virtual machine, the host operating system for the computing system 100, and the underlying physical hardware of the computing system 100. For example, the hypervisor can create and configure the virtual machine by virtualizing the physical memory of the computing system 100 so that the guest operating system can manage its own contiguous physical memory (e.g., second memory page 104b). When the virtual machine attempts to access the second memory page 104b after the second memory page 104b is discarded, the hypervisor may inject a memory error interrupt into the virtual machine. The virtual machine may, in some examples, be configured to adjust to the memory error interrupt and continue execution. In other examples, the hypervisor can restart the virtual machine.

Although FIG. 1 depicts a certain number and arrangement of components, other examples may include more components, fewer components, different components, or a different number of the components that is shown in FIG. 1. For instance, the computing system 100 can include more or fewer processes 102a-c or memory pages 104a-e than are shown in FIG. 1.

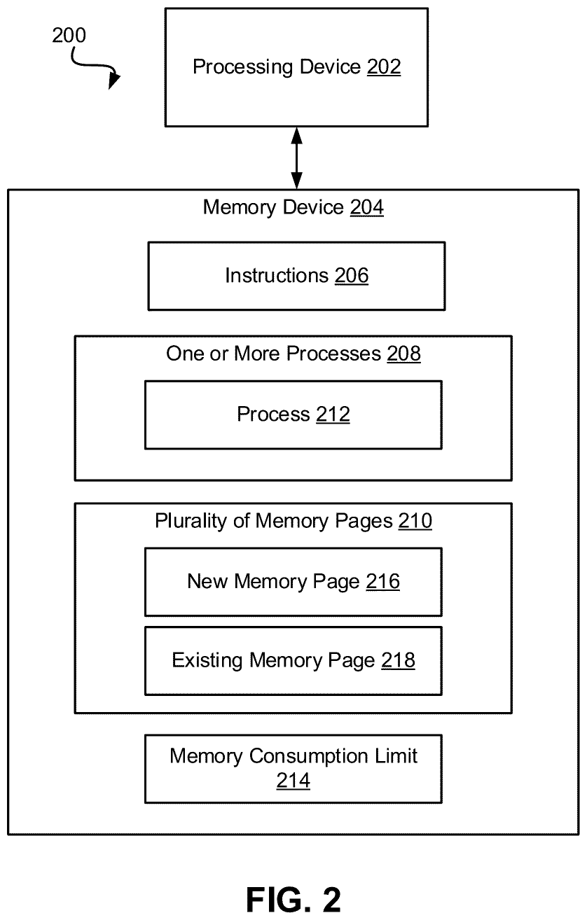

FIG. 2 is a block diagram of another example of a computing system 200 for write-only swapping of memory pages, according to some aspects of the present disclosure. The computing system 200 depicted in FIG. 2 includes a processing device 202 communicatively coupled with a memory device 204. In some examples, the components of the computing system 200, such as the processing device 202 and the memory device 204, may be part of a same computing device. In other examples, the processing device 202 and the memory device 204 can be included in separate computing devices that are communicatively coupled.

The processing device 202 can include one processing device or multiple processing devices. Non-limiting examples of the processing device 202 include a Field-Programmable Gate Array (FPGA), an application-specific integrated circuit (ASIC), a microprocessor, etc. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C #, etc.

The memory device 204 can include one memory or multiple memories. The memory device 204 can be non-volatile and may include any type of memory that retains stored information when powered off. Non-limiting examples of the memory device 204 include electrically erasable and programmable read-only memory (EEPROM), flash memory, or any other type of non-volatile memory. At least some of the memory can include a non-transitory computer-readable medium from which the processing device 202 can read instructions 206. The non-transitory computer-readable medium can include electronic, optical, magnetic, or other storage devices capable of providing the processing device with computer-readable instructions or other program code. Examples of the non-transitory computer-readable medium include magnetic disk(s), memory chip(s), ROM, RAM, an ASIC, a configured processor, optical storage, or any other medium from which a computer processor can read the instructions 206.

In some examples, the processing device 202 can execute the instructions 206 to perform some or all of the functionality described herein. For example, the processing device 202 can execute one or more processes 208 accessing a plurality of memory pages 210. The processing device 202 can request, by a process 212 of the one or more processes 208, a new memory page 216. The processing device 202 can determine that a memory consumption limit 214 predefined for the memory device 204 has been exceeded by the one or more processes 208. The processing device 202 can, in response to (i) requesting the new memory page 216 and (ii) determining that the memory consumption limit 214 has been exceeded, discard an existing memory page 218 of the plurality of memory pages 210. The processing device 202 can allocate the new memory page 216 for the process 212 subsequent to discarding the existing memory page 218.

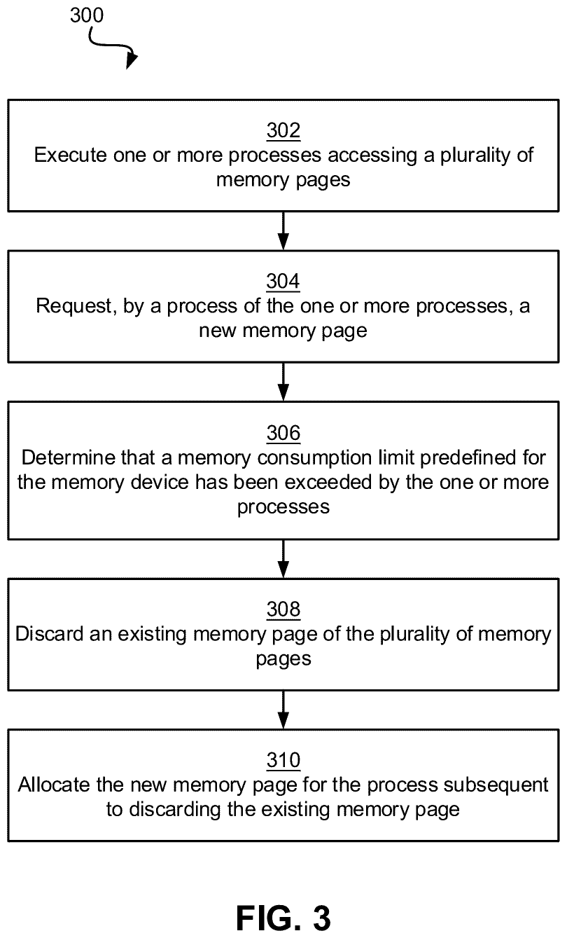

FIG. 3 is a flowchart of an example of a process 300 for write-only swapping of memory pages in a computing system, according to some aspects of the present disclosure. In some examples, the processing device 202 can implement some or all of the steps shown in FIG. 2. Additionally, in some examples, the processing device 202 can be executing the MMU 106, the swap device 108, the computing system 100, or any suitable component of FIGS. 1-2 to implement some or all of the steps shown in FIG. 3. Other examples can include more steps, fewer steps, different steps, or a different order of the steps than is shown in FIG. 3. The steps of FIG. 3 are discussed below with reference to the components discussed above in relation to FIGS. 1-2.

At block 302, the processing device 202 can execute one or more processes 208 accessing a plurality of memory pages 210. For example, the one or more processes 208 may be applications, multiple virtual machines, or multiple containers executing on a single host. Each of the one or more processes 208 can request allocation of memory pages to store data. The one or more processes 208 may also, in some cases, request access to the data in the plurality of memory pages 210 at a later time. At block 304, the processing device 202 can request, by a process 212 of the one or more processes 208, a new memory page 216.

At block 306, the processing device 202 can determine that a memory consumption limit 214 predefined for the memory device 204 has been exceeded by the one or more processes 208. The memory consumption limit 214 may be a memory limit that the processing device 202 has set for the one or more processes 102a-c. For example, when the memory consumption limit 214 is exceeded, the memory device 204 may have no more available memory to be allocated.

At block 308, the processing device 202 can, in response to (i) requesting the new memory page 216 and (ii) determining that the memory consumption limit 214 has been exceeded, discard an existing memory page 218 of the plurality of memory pages 210. In some examples, the existing memory page 218 may be discarded based on its least recently used (LRU) score 112. In other examples, the existing memory page 218 may be discarded based on its LRU score 112 and an out of memory (OOM) score 114 for a process associated with the existing memory page 218 (e.g., the process that requested the existing memory page 218). For example, the LRU score 112 for each memory page of the plurality of memory pages 210 can be multiplied by the OOM score 114 for its corresponding process of the one or more processes 208 to generate an adjusted LRU score. The memory page with the highest adjusted LRU score can be the existing memory page 218 that is discarded.

At block 310, the processing device 202 can allocate the new memory page 216 for the process 212 subsequent to discarding the existing memory page 218. In some examples, the processing device 202 can discard the existing memory page 218 without swapping the existing memory page 218 to another storage device, such as swap device 108. Thus, only writing of memory pages may be enabled while reading is disabled for the computing system 200 when the memory consumption limit 214 is exceeded.

In some examples, subsequent to discarding the existing memory page 218, a second process (e.g., second process 102b) can request access to the discarded existing memory page 218. In response, the processing device 202 can kill the second process 102b. In some examples, the processing device 202 can restart the second process 102b subsequent to killing the second process 102b. In other examples, subsequent to discarding the existing memory page 218 and in response to the second process 102b requesting access to the existing memory page 218, the processing device 202 can send a segmentation fault 116 to the second process 102b. In some examples, the segmentation fault 116 can kill the second process 102b. In other examples, the second process 102b can recover from the segmentation fault 116 without being killed.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a non-transitory memory device comprising instructions that are executable by the processing device for causing the processing device to:
execute one or more processes accessing a plurality of memory pages;
request, by a process of the one or more processes, a new memory page;
determine that a memory consumption limit predefined for the memory device has been exceeded by the one or more processes;
discard an existing memory page of the plurality of memory pages in response to (i) requesting the new memory page and (ii) determining that the memory consumption limit has been exceeded; and
allocate the new memory page for the process subsequent to discarding the existing memory page.

2. The system of claim 1, wherein the new memory page is a first memory page and the existing memory page that is discarded is a second memory page, wherein the process is a first process, and wherein the memory device further comprises instructions that are executable by the processing device for causing the processing device to, subsequent to discarding the second memory page:
request, by a second process of the one or more processes, access to the second memory page; and
send a signal to the second process indicating that the second memory page has been discarded in response to requesting access to the second memory page.

3. The system of claim 1, wherein the memory device further comprises instructions that are executable by the processing device for causing the processing device to:
generate, for each memory page of the plurality of memory pages, a least recently used (LRU) score;
generate, for each process of the one or more processes, an out-of-memory (OOM) score; and
select the existing memory page to discard based on the LRU score for the existing memory page and on the OOM score for a corresponding process of the one or more processes that is associated with the existing memory page.

4. The system of claim 1, wherein the new memory page is a first memory page and the existing memory page that is discarded is a second memory page, wherein the process is a first process, and wherein the memory device further comprises instructions that are executable by the processing device for causing the processing device to subsequent to discarding the second memory page:
request, by a second process of the one or more processes, access to the second memory page; and
send a segmentation fault to the second process in response to requesting access to the second memory page.

5. The system of claim 1, wherein the new memory page is a first memory page and the existing memory page that is discarded is a second memory page, and wherein the memory device further comprises instructions that are executable by the processing device for causing the processing device to discard the second memory page by:
moving the second memory page to a swap device; and
discarding, by the swap device, the second memory page.

6. The system of claim 5, wherein the process is a first process, and wherein the memory device further comprises instructions that are executable by the processing device for causing the processing device to, subsequent to moving the second memory page to the swap device:
request, by a second process of the one or more processes, access to the second memory page; and
send, by the swap device, an error in response to requesting access to the second memory page.

7. The system of claim 1, wherein the memory device further comprises instructions that are executable by the processing device for causing the processing device to discard the existing memory page without swapping the existing memory page to another storage device.

8. A method comprising:
executing, by a processor, one or more processes accessing a plurality of memory pages;
requesting, by the processor executing a process of the one or more processes, a new memory page;
determining, by the processor, that a memory consumption limit predefined for a memory device has been exceeded by the one or more processes;
discarding, by the processor, an existing memory page of the plurality of memory pages in response to (i) requesting the new memory page and (ii) determining that the memory consumption limit has been exceeded; and
allocating, by the processor, the new memory page for the process subsequent to discarding the existing memory page.

9. The method of claim 8, wherein the new memory page is a first memory page and the existing memory page that is discarded is a second memory page, and wherein the method further comprises, subsequent to discarding the second memory page:
requesting, by a second process of the one or more processes, access to the second memory page; and
sending a signal to the second process indicating that the second memory page has been discarded in response to requesting access to the second memory page.

10. The method of claim 8, further comprising:
generating, for each memory page of the plurality of memory pages, a least recently used (LRU) score;
generating, for each process of the one or more processes, an out-of-memory (OOM) score; and
selecting the existing memory page to discard based on the LRU score for the existing memory page and on the OOM score for a corresponding process of the one or more processes that is associated with the existing memory page.

11. The method of claim 8, wherein the new memory page is a first memory page and the existing memory page that is discarded is a second memory page, wherein the process is a first process, and wherein the method further comprises, subsequent to discarding the second memory page:
requesting, by a second process of the one or more processes, access to the second memory page; and
sending a segmentation fault to the second process in response to requesting access to the second memory page.

12. The method of claim 8, wherein the new memory page is a first memory page and the existing memory page that is discarded is a second memory page, and wherein the method further comprises discarding the second memory page by:
moving the second memory page to a swap device; and
discarding, by the swap device, the second memory page.

13. The method of claim 12, wherein the process is a first process, and wherein the method further comprises, subsequent to moving the second memory page to the swap device:
request, by a second process of the one or more processes, access to the second memory page; and
send, by the swap device, an error in response to requesting access to the second memory page.

14. The method of claim 8, wherein discarding the existing memory page further comprises discarding the existing memory page without swapping the existing memory page to another storage device.

15. A non-transitory computer-readable storage medium comprising program code that is executable by a processing device for causing the processing device to:
execute one or more processes accessing a plurality of memory pages;
request, by a process of the one or more processes, a new memory page;
determine that a memory consumption limit predefined for a memory device has been exceeded by the one or more processes;
discard an existing memory page of the plurality of memory pages in response to (i) requesting the new memory page and (ii) determining that the memory consumption limit has been exceeded; and
allocate the new memory page for the process subsequent to discarding the existing memory page.

16. The non-transitory computer-readable storage medium of claim 15, wherein the new memory page is a first memory page and the existing memory page that is discarded is a second memory page, wherein the process is a first process, and wherein the program code is further executable by the processing device for causing the processing device to, subsequent to discarding the second memory page:
request, by a second process of the one or more processes, access to the second memory page; and
sending a signal to the second process indicating that the second memory page has been discarded in response to requesting access to the second memory page.

17. The non-transitory computer-readable storage medium of claim 15, wherein the program code is further executable by the processing device for causing the processing device to:
generate, for each memory page of the plurality of memory pages, a least recently used (LRU) score;
generate, for each process of the one or more processes, an out-of-memory (OOM) score; and
select the existing memory page to discard based on the LRU score for the existing memory page and on the OOM score for a corresponding process of the one or more processes that is associated with the existing memory page.

18. The non-transitory computer-readable storage medium of claim 15, wherein the new memory page is a first memory page and the existing memory page that is discarded is a second memory page, wherein the process is a first process, and wherein the program code is further executable by the processing device for causing the processing device to, subsequent to discarding the second memory page:
request, by a second process of the one or more processes, access to the second memory page; and
send a segmentation fault to the second process in response to requesting access to the second memory page.

19. The non-transitory computer-readable storage medium of claim 15, wherein the new memory page is a first memory page and the existing memory page that is discarded is a second memory page, and wherein the program code is further executable by the processing device for causing the processing device to discard the second memory page by:
moving the second memory page to a swap device; and
discarding, by the swap device, the second memory page.

20. The non-transitory computer-readable storage medium of claim 19, wherein the process is a first process, and wherein the program code is further executable by the processing device for causing the processing device to, subsequent to moving the second memory page to the swap device:
request, by a second process of the one or more processes, access to the second memory page; and
send, by the swap device, an error in response to requesting access to the second memory page.
